(19) United States
(12) Patent Application Publication
(10) Pub. No.: US 2025/0210709 A1
(43) Pub. Date: Jun. 26, 2025

(54) ELECTROLYTE FOR RECHARGEABLE LITHIUM BATTERY AND RECHARGEABLE LITHIUM BATTERY INCLUDING THE SAME

(71) Applicant: Samsung SDI Co., Ltd., Yongin-si (KR)

(72) Inventors: Sangwoo PARK, Yongin-si (KR); Hongryeol PARK, Yongin-si (KR); Hyunbong CHOI, Yongin-si (KR); Sanghoon KIM, Yongin-si (KR); Sohee KIM, Yongin-si (KR); Injun PARK, Yongin-si (KR); Yeji YANG, Yongin-si (KR); Dasol JUN, Yongin-si (KR)

(21) Appl. No.: 18/776,080

(22) Filed: Jul. 17, 2024

(30) Foreign Application Priority Data
Dec. 20, 2023 (KR) 10-2023-0187737

(51) Int. Cl. H01M 10/0567; H01M 4/02; H01M 4/525; H01M 10/0525; H01M 10/0568; H01M 10/0569; H01M 10/42

(52) U.S. Cl. CPC H01M 10/0567; H01M 4/525; H01M 10/0525; H01M 10/0568; H01M 10/0569; H01M 10/4235; H01M 2004/028; H01M 2300/004

(57) ABSTRACT

An electrolyte for a rechargeable lithium battery includes a non-aqueous organic solvent; a lithium salt; a first additive represented by represented by Chemical Formula 1; and a second additive represented by represented by Chemical Formula 2:

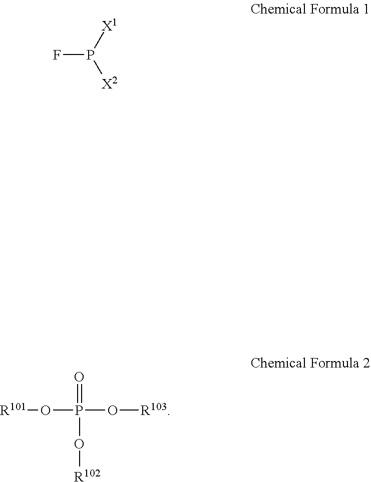

In addition, a rechargeable lithium battery including the electrolyte is also disclosed.

### CROSS-REFERENCE TO RELATED APPLICATION

The present application claims priority to and the benefit of Korean Patent Application No. 10-2023-0187737, filed on Dec. 20, 2023, in the Korean Intellectual Property Office, the entire content of which is incorporated herein by reference.

### BACKGROUND

### (a) Field

One or more embodiments of the present disclosure relate an electrolyte for a rechargeable lithium battery and a rechargeable lithium battery including the electrolyte.

### (b) Description of Related Art

A rechargeable lithium battery may be recharged and has three or more times in energy density per unit weight as that of a comparable lead storage battery, nickel-cadmium battery, nickel hydrogen battery, nickel zinc battery, and/or the like. The rechargeable lithium battery may be also charged at a relatively high rate and thus, is commercially manufactured for a laptop, a cell phone, an electric tool, an electric bike, and/or the like, and research on improvement of additional energy density has been actively conducted or pursued.

Such a rechargeable lithium battery is manufactured by injecting an electrolyte into an electrode assembly, which includes a positive electrode including a positive electrode active material capable of intercalating/deintercalating lithium ions and a negative electrode including a negative electrode active material capable of intercalating/deintercalating lithium ions.

As charging and discharging of a rechargeable lithium battery is repeated, transition metal ions in the positive electrode active material of the rechargeable lithium battery are eluted into the electrolyte, and the transition metal ions eluted into the electrolyte are reduced on the surface of the negative electrode of the rechargeable lithium battery. Accordingly, side reactions (e.g., gas generation, increased interface resistance, and/or the like.) occur at the interface between the negative electrode and the electrolyte, and cycle-life of the rechargeable lithium battery may be reduced.

The above problems become more severe if (e.g., when) the rechargeable lithium battery is driven at high temperature and/or charged at high voltage.

### SUMMARY

One or more aspects of embodiments of the present disclosure are directed toward an electrolyte for a rechargeable lithium battery which suppresses side reactions (e.g., gas generation, increase in interface resistance, and/or the like.) that occur at the interface between the negative electrode of the rechargeable lithium battery and the electrolyte, regardless of operating temperature and upper charging limit voltage, and improves cycle-life of the rechargeable lithium battery.

One or more aspects of embodiments of the present disclosure are directed toward a rechargeable lithium battery including the electrolyte.

Additional aspects will be set forth in part in the description which follows and, in part, will be apparent from the description, or may be learned by practice of the presented embodiments of the disclosure.

According to one or more embodiments of the present disclosure, an electrolyte for a rechargeable lithium battery includes a non-aqueous organic solvent; a lithium salt; a first additive represented by represented by Chemical Formula 1; and a second additive represented by represented by Chemical Formula 2:

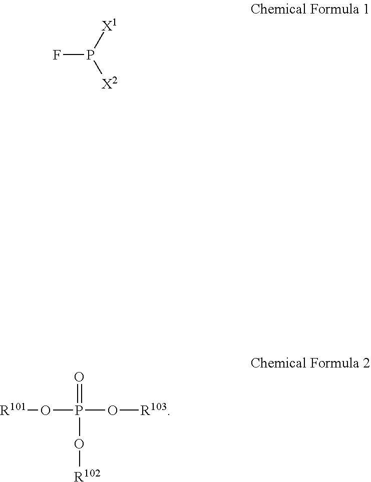

According to one or more embodiments of the present disclosure, a rechargeable lithium battery includes a positive electrode including a positive electrode active material; a negative electrode including a negative electrode active material; and the electrolyte.

The electrolyte according to one or more embodiments may suppress or reduce side reactions (e.g., gas generation, increase in interface resistance, and/or the like.) that occur at the interface between the negative electrode and the electrolyte, regardless of operating temperature and upper charging limit voltage, and may improve cycle-life of a rechargeable lithium battery.

### BRIEF DESCRIPTION OF DRAWINGS

The above and other aspects, features, and advantages of certain embodiments of the present disclosure will be more apparent from the following description taken in conjunction with the accompanying drawings.

FIGS. 1-4 are each a schematic view showing a rechargeable lithium battery according to one or more embodiments of the present disclosure.

### DETAILED DESCRIPTION

The present disclosure may be modified in many alternate forms, and thus specific embodiments will be exemplified in the drawing and described in more detail. It should be understood, however, that it is not intended to limit the present disclosure to the particular forms disclosed, but rather, is intended to cover all modifications, equivalents, and alternatives falling within the spirit and scope of the present disclosure.

Hereinafter, embodiments of the present disclosure will be described in more detail. However, these embodiments are mere examples, the present disclosure is not limited thereto and the present disclosure is defined by the scope of claims and equivalents thereof.

As utilized herein, if (e.g., when) a specific definition is not otherwise provided, it will be understood that if (e.g., when) an element such as a layer, film, region, or substrate is referred to as being “on” another element, it may be directly on the other element or intervening elements may also be present. In contrast, “directly on” may refer to that there is no additional layer, film, area, and/or plate between a part such as a layer, film, area and another part. For example, “directly on” may refer to that two layers or two members are arranged without utilizing an additional member such as an adhesive member therebetween.

As utilized herein, if (e.g., when) a specific definition is not otherwise provided, the singular forms “a,” “an,” and “the” are intended to include the plural forms as well, unless the context clearly indicates otherwise. In one or more embodiments, unless otherwise specified, “A or B” or “A and/or B” may refer to “including A, including B, or including A and B.” Expressions such as “at least one of,” “one of,” and “selected from,” when preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. The “/” utilized herein may be interpreted as “and” or as “or” depending on the situation. Further, the utilization of “may” when describing embodiments of the present disclosure refers to “one or more embodiments of the present disclosure.”

As utilized herein, “combination thereof” may refer to a mixture of constituents, a stack, a composite, a copolymer, an alloy, a blend, and a reaction product.

As utilized herein, if (e.g., when) a specific definition is not otherwise provided, “substituted” refers to replacement of at least one hydrogen of a compound by a substituent selected from among a halogen (F, Cl, Br, or I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, and/or a (e.g., any suitable) combination thereof.

As utilized herein, if (e.g., when) a specific definition is not otherwise provided, “heterocycloalkyl group,” “heterocycloalkenyl group,” “heterocycloalkynyl group,” and “heterocycloalkylene group” refers to that at least one heteroatom of N, O, S, or P is present in the ring compound of cycloalkyl, cycloalkenyl, cycloalkynyl, and cycloalkylene, respectively.

In chemical formulas of the present disclosure, unless a specific definition is otherwise provided, hydrogen is bonded at the position if (e.g., when) a chemical bond is not drawn where supposed to be given.

### Electrolyte

According to one or more embodiments of the present disclosure, an electrolyte for a rechargeable lithium battery may include a non-aqueous organic solvent; a lithium salt; a first additive represented by represented by Chemical Formula 1; and a second additive represented by represented by Chemical Formula 2:

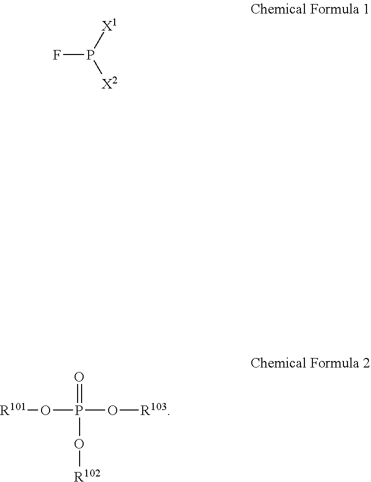

The first additive and the second additive correspond to a phosphorus-based additive. For example, the first additive is a phosphite-based additive, and the second additive is a phosphate-based additive.

Accordingly, the first additive and the second additive may be oxidized and decomposed on the surface of a positive electrode of the rechargeable lithium battery to form a robust positive electrode protective layer (CEI, Cathode Electrolyte Interface).

The positive electrode protective layer formed by oxidative decomposition of the first additive and the second additive may prevent or reduce transition metal ions in a positive electrode active material of the positive electrode from eluting into the electrolyte and moving to a negative electrode of the rechargeable lithium battery. As a result, side reactions that occur at the interface between the negative electrode and the electrolyte (e.g., gas generation, increase in interface resistance, and/or the like.) may be suppressed or reduced and cycle-life of the rechargeable lithium battery can be improved.

Furthermore, the second additive has a P═O double bond in its molecular structure, and the P═O double bond may facilitate the movement of lithium ions within the positive electrode protective layer.

To sum up, the positive electrode protective layer formed by oxidative decomposition of the first additive and the second additive may facilitate the movement of lithium ions within the positive electrode protective layer by the second additive, while suppressing or reducing transition metal ions in the positive electrode active material from eluting into the electrolyte and moving to the negative electrode.

The effect is effectively exhibited even if the operating temperature of the rechargeable lithium battery is increased and/or the upper charging limit voltage is increased.

Hereinafter, the electrolyte for a rechargeable lithium battery of one or more embodiments will be described in more detail.

### First Additive

In Chemical Formula 1, X¹ and X² may each independently be a halogen or —O-L¹-R¹, and at least one of X¹ or X² is —O-L¹-R¹.

L¹ may be a single bond or a substituted or unsubstituted C₁ to C10 alkylene group.

R¹ may be a cyano group (—CN), a difluorophosphite group (—OPF₂), a substituted or unsubstituted C1 to C10 alkyl group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group.

When X¹ and X² are —O-L¹-R¹ at the same time, R¹ may each independently be present.

In one or more embodiments, one selected from among X¹ and X² may be fluorine and the other may be O-L²-R².

L² may be a single bond or a substituted or unsubstituted C1 to C10 alkylene group.

R² may be a cyano group (—CN) or a difluorophosphite group (—OPF₂).

When X¹ and X² are concurrently (e.g., simultaneously) —O-L¹-R¹, independently of the foregoing description, two R¹s may be linked to form a substituted or unsubstituted monocyclic or polycyclic C6 to C20 aliphatic heterocycle or a substituted or unsubstituted monocyclic or polycyclic C6 to C20 aromatic heterocycle.

In one or more embodiments, among X¹ and X², one may be —O-L³-R³ and the other may be —O-L⁴-R⁴.

L³ and L⁴ may each independently be a single bond or a substituted or unsubstituted C1 to C10 alkylene group.

R³ and R⁴ may each independently be a substituted or unsubstituted C1 to C10 alkyl group. In one or more embodiments, R³ and R⁴ may be linked to form a substituted or unsubstituted monocyclic or polycyclic C3 to C10 aliphatic heterocycle.

For example, in one or more embodiments, the first additive represented by Chemical Formula 1 may be represented by Chemical Formula 1-1 or Chemical Formula 1-2:

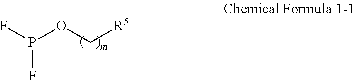

In Chemical Formula 1-1, m may be an integer of 1 to 5; and R⁵ may be a cyano group (—CN) or a difluorophosphite group (—OPF₂).

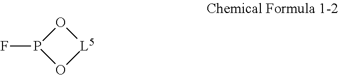

In Chemical Formula 1-2, L⁵ may be a substituted or unsubstituted C1 to C5 alkylene group.

In one or more embodiments, the first additive represented by Chemical Formula 1-2 may be represented by Chemical Formula 1-2a or Chemical Formula 1-2b:

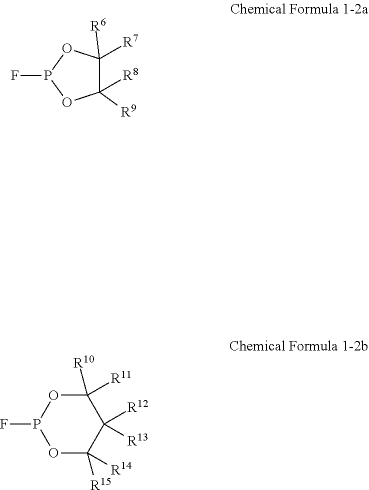

In Chemical Formula 1-2a and Chemical Formula 1-2b, R⁶ to R¹⁵ may each independently be hydrogen, a halogen, or a substituted or unsubstituted C1 to C5 alkyl group.

In one or more embodiments, the first additive may include at least one compound selected from among compounds represented by Chemical Formula 1-1a-1, Chemical Formula 1-1a-2, Chemical Formula 1-2a-1, and Chemical Formula 1-2a-2:

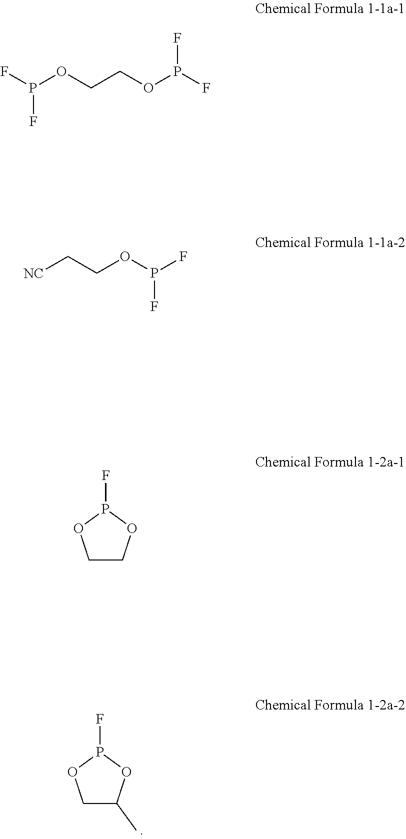

### Second Additive

In Chemical Formula 2, R¹⁰¹ to R¹⁰³ may each independently be a substituted or unsubstituted C1 to C10 alkyl group, a substituted or unsubstituted C6 to C10 aryl group, or a substituted or unsubstituted C2 to C10 heteroaryl group containing a heteroatom of N, O, or P, or two selected from among R¹⁰¹ to R¹⁰³ may be linked to form a substituted or unsubstituted monocyclic or polycyclic C6 to C20 aliphatic heterocycle or a substituted or unsubstituted monocyclic or polycyclic C6 to C20 aromatic heterocycle, and the remaining one group may be a substituted or unsubstituted C1 to C10 alkyl group, a substituted or unsubstituted C6 to C10 aryl group, or a substituted or unsubstituted C2 to C10 heteroaryl group containing a heteroatom of N, O, or P.

In one or more embodiments, R¹⁰¹ to R¹⁰³ may each independently be a substituted or unsubstituted C1 to C5 alkyl group or a substituted or unsubstituted C6 to C10 aryl group.

In one or more embodiments, two selected from among R¹⁰¹ to R¹⁰³ may be linked to form a substituted or unsubstituted monocyclic C6 to C10 aliphatic heterocycle, and the remaining one group may be a substituted or unsubstituted C1 to C5 alkyl group.

In one or more embodiments, the second additive may include at least one compound selected from among compounds represented by Chemical Formulae 2-1 to 2-9:

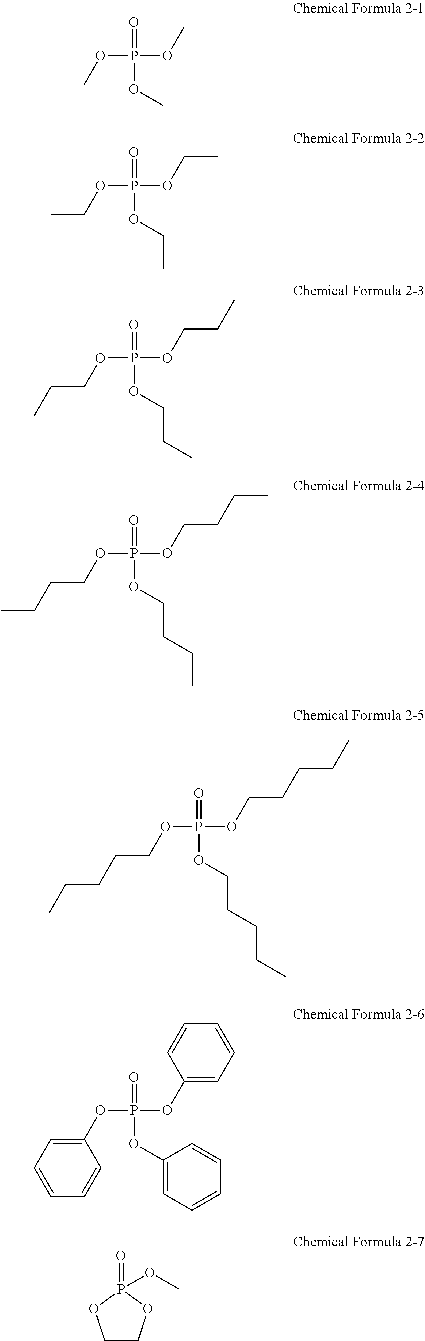

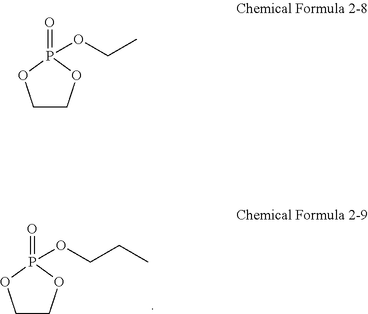

### Mixing Ratio (Weight Ratio) of First Additive to Second Additive

In one or more embodiments, a weight ratio of the first additive to the second additive may be about 10:1 to about 1:10. Within this range, there is a synergistic effect due to the combination of the two types (kinds) of additives.

For example, in one or more embodiments, the weight ratio of the first additive to the second additive may be about 10:1 to about 1:10, about 10:1 to about 1:5, or about 10:1 to about 1:2.

### Content of First Additive

In one or more embodiments, the first additive may be included in an amount of about 0.1 to about 5 wt % based on a total amount (e.g., total weight) of the electrolyte. Within this range, the effect of the first additive may be increased.

For example, in one or more embodiments, the first additive may be included in an amount of about 0.1 to about 5 wt %, about 0.1 to about 2.5 wt %, or about 0.1 to about 1 wt %, based on a total amount (e.g., total weight) of the electrolyte.

### Content of Second Additive

In one or more embodiments, the second additive may be included in an amount of about 0.1 to about 10 wt % based on a total amount (e.g., total weight) of the electrolyte. Within this range, the effect of the second additive may be increased.

For example, in one or more embodiments, the first additive may be included in an amount of about 0.1 to about 10 wt %, about 0.1 to about 5 wt %, or about 0.1 to about 2.5 wt %, based on a total amount (e.g., total weight) of the electrolyte.

### Non-Aqueous Organic Solvent

The non-aqueous organic solvent serves as a medium for transmitting ions taking part in the electrochemical reaction of a battery.

The non-aqueous organic solvent may be a carbonate-based solvent, an ester-based solvent, an ether-based solvent, a ketone-based solvent, an alcohol-based solvent, an aprotic solvent, or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and/or the like. The ester-based solvent may include methyl acetate, ethyl acetate, n-propyl acetate, dimethylacetate, methylpropionate, ethylpropionate, decanolide, mevalonolactone, valerolactone, caprolactone, and/or the like. The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone. The alcohol-based solvent may include ethyl alcohol, isopropyl alcohol, and/or the like, and the aprotic solvent may include nitriles such as R—CN (wherein R is a C2 to C20 linear, branched, or cyclic hydrocarbon group, and may include a double bond, an aromatic ring, or an ether group), amides such as dimethylformamide, dioxolanes such as 1,3-dioxolane and/or 1,4-dioxolane, sulfolanes, and/or the like.

The non-aqueous organic solvent may be utilized alone or in combination of two or more thereof.

In some embodiments, if (e.g., when) utilizing a carbonate-based solvent, a cyclic carbonate and a chain carbonate may be mixed and utilized, and the cyclic carbonate and the chain carbonate may be mixed at a volume ratio of about 1:1 to about 1:9.

In one or more embodiments, the non-aqueous organic solvent may be a mixture of ethylene carbonate (EC), ethylmethyl carbonate (EMC), and dimethyl carbonate (DMC). A volume ratio thereof is not particularly limited.

### Lithium Salt

The lithium salt dissolved in the non-aqueous organic solvent supplies lithium ions in a battery, enables a basic operation of a rechargeable lithium battery, and improves transportation of the lithium ions between positive and negative electrodes. Non-limiting examples of a lithium salt may include one or more selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (x and y are each an integer from 1 to 20), lithium trifluoromethane sulfonate, lithium tetrafluoroethanesulfonate, lithium difluorobis(oxalato)phosphate (LiDBOP), and lithium bis(oxalato)borate (LiBOB).

For example, in some embodiments, LiPF₆ may be utilized as the lithium salt.

A molar concentration of the lithium salt in the electrolyte may be about 1.0 to about 2.0 M.

### Rechargeable Lithium Battery

According to one or more embodiments of the present disclosure, a rechargeable lithium battery may include: a positive electrode including a positive electrode active material; a negative electrode including a negative electrode active material; and the electrolyte according to one or more embodiments.

In the rechargeable lithium battery including the electrolyte of one or more embodiments, side reactions (e.g., gas generation, increase in interface resistance, and/or the like.) occurring at the interface between the negative electrode and the electrolyte may be suppressed or reduced, and cycle-life of the rechargeable lithium battery may be improved.

Hereinafter, descriptions that overlap with the above will not be provided for conciseness, and the rechargeable lithium battery will be described in more detail.

### Upper Charging Limit Voltage

As described above, if (e.g., when) a rechargeable lithium battery is charged at relatively high voltage, the amount of elution of transition metal ions in the positive electrode active material increases.

However, if a robust film is formed on the surface of the positive electrode utilizing the electrolyte of one or more embodiments, the elution of transition metal ions in the positive electrode active material may be suppressed or reduced even if (e.g., when) charged at relatively high voltage.

For example, in one or more embodiments, the upper charging limit voltage of the rechargeable lithium battery may be greater than or equal to about 4.3 V, greater than or equal to about 4.4 V, or greater than or equal to about 4.45 V.

### Positive Electrode Active Material

The positive electrode active material may be a compound (lithiated intercalation compound) capable of intercalating and deintercalating lithium. For example, one or more types (kinds) of composite oxides of lithium and a metal selected from among cobalt, manganese, nickel, and/or a (e.g., any suitable) combination thereof may be utilized.

The composite oxide may be a lithium transition metal composite oxide, and non-limiting examples thereof may include lithium nickel-based oxides, lithium cobalt-based oxides, lithium manganese-based oxides, lithium iron phosphate-based compounds, cobalt-free lithium nickel-manganese-based oxides, and/or a (e.g., any suitable) combination thereof.

In one or more embodiments, a compound represented by any of the following chemical formulas may be utilized: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α}(0.90≤a≤1.8, 0≤b≤0.5, 0≤c≤0.5, 0≤α≤2); LiₐNi_{1-b-c}Mn_{b}X_{c}O_{2-α}D_{α}(0.90≤a≤1.8, 0≤b≤0.5, 0≤c≤0.5, 0≤α≤2); LiₐNi_{b}Co_{c}L^{1-d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A may be nickel (Ni), cobalt (Co), manganese (Mn), and/or a (e.g., any suitable) combination thereof; X may be aluminum (Al), Ni, Co, Mn, chromium (Cr), iron (Fe), magnesium (Mg), strontium (Sr), vanadium (V), a rare earth element, and/or a (e.g., any suitable) combination thereof; D may be oxygen (O), fluorine (F), sulfur (S), phosphorous (P), and/or a (e.g., any suitable) combination thereof; G may be Al, Cr, Mn, Fe, Mg, lanthanum (La), cerium (Ce), Sr, V, and/or a (e.g., any suitable) combination thereof; and L¹ may be Mn, Al, and/or a (e.g., any suitable) combination thereof.

In one or more embodiments, the positive electrode active material may be, for example, a lithium nickel-based oxide represented by Chemical Formula 11, a lithium cobalt-based oxide represented by Chemical Formula 12, a lithium iron phosphate-based compound represented by Chemical Formula 13, a cobalt-free lithium nickel-manganese-based oxide represented by Chemical Formula 14, and/or a (e.g., any suitable) combination thereof.

Liₐ₁Niₓ₁M¹_{y1}M²_{z1}O_{2-b1}X_{b1} Chemical Formula 11

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² may each independently be one or more selected from among aluminum (Al), boron (B), barium (Ba), calcium (Ca), cerium (Ce), cobalt (Co), chromium (Cr), copper (Cu), iron (Fe), magnesium (Mg), manganese (Mn), molybdenum (Mo), niobium (Nb), silicon (Si), tin (Sn), strontium (Sr), titanium (Ti), vanadium (V), tungsten (W), and zirconium (Zr), and X may be one or more selected from among fluorine (F), phosphorus (P), and sulfur (S).

In some embodiments, in Chemical Formula 11, 0.6≤x1≤1, 0≤y1≤0.4, and 0≤z1≤0.4, or 0.8≤x1≤1, 0≤y1≤0.2, and 0≤z1≤0.2.

Liₐ₂COₓ₂M³_{y2}O_{2-b2}X_{b2} Chemical Formula 12

In Chemical Formula 12, 0.9≤a2≤1.8, 0.7≤x2≤1, 0≤y2≤0.3, 0.9≤x2+y2≤1.1, and 0≤b2≤0.1, M³ may be one or more selected from among Al, B, Ba, Ca, Ce, Cr, Cu, Fe, Mg, Mn, Mo, Ni, Se, Si, Sn, Sr, Ti, V, W, Y, Zn, and Zr, and X may be one or more selected from among F, P, and S.

Liₐ₃Feₓ₃M⁴_{y3}PO_{4-b3}X_{b3} Chemical Formula 13

In Chemical Formula 13, 0.9≤a3≤1.8, 0.6≤x3≤1, 0≤y3≤0.4, and 0≤b3≤0.1, M⁴ may be one or more selected from among Al, B, Ba, Ca, Ce, Co, Cr, Cu, Mg, Mn, Mo, Ni, Se, Si, Sn, Sr, Ti, V, W, Y, Zn, and Zr, and X may be one or more selected from among F, P, and S.

Liₐ₄Niₓ₄Mfn_{y4}M⁵_{z4}O_{2-b4}X_{b4} Chemical Formula 14

In Chemical Formula 14, 0.9≤a4≤1.8, 0.8≤x4<1, 0≤y4≤0.2, 0≤z4≤0.2, 0.9≤x4+y4+z4≤1.1, and 0≤b4≤0.1, M⁵ may be one or more element selected from among Al, B, Ba, Ca, Ce, Cr, Fe, Mg, Mo, Nb, Si, Sn, Sr, Ti, V, W, and Zr, and X may be one or more selected from among F, P, and S.

For example, in one or more embodiments, the positive electrode active material may be a cobalt-free nickel-manganese-based oxide represented by Chemical Formula 14. Because the cobalt-free nickel-manganese-based oxide does not contain cobalt, it has the advantage of being cheaper than the positive electrode active material containing cobalt.

However, the cobalt-free nickel-manganese-based oxide has an unstable structure due to the absence of cobalt, and nickel ions and/or manganese ions are likely to be eluted.

However, if a robust film is formed on the surface of the positive electrode including the cobalt-free nickel-manganese-based oxide utilizing the electrolyte of one or more embodiments, the elution of nickel ions and/or manganese ions in the cobalt-free nickel-manganese-based oxide into the electrolyte may be suppressed or reduced.

For example, in one or more embodiments, the positive electrode active material may be a high nickel-based positive electrode active material having a nickel content (e.g., amount) of greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of metals excluding lithium in the lithium transition metal composite oxide. The high nickel-based positive electrode active materials may achieve relatively high capacity and may be applied to a high-capacity, high-density rechargeable lithium battery.

However, the high nickel-based positive electrode active material has relatively high nickel activity, so that a large amount of nickel ions are likely to be eluted from the high nickel-based positive electrode active material.

However, if a robust film is formed on the surface of the positive electrode including the high nickel-based positive electrode active material utilizing the electrolyte of one or more embodiments, it may suppress or reduce nickel ions in the high nickel-based positive electrode active material from eluting into the electrolyte.

In one or more embodiments, the positive electrode active material may be a cobalt-free nickel-manganese-based oxide, and may be a high nickel-based positive electrode active material having a nickel content (e.g., amount) of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of metals excluding lithium in the cobalt-free nickel-manganese-based oxide. Even in these embodiments, the above-described effects may be effectively exhibited.

### Positive Electrode

The positive electrode for a rechargeable lithium battery may include a positive electrode current collector and a positive electrode active material layer on the positive electrode current collector. The positive electrode active material layer may include a positive electrode active material and may further include a binder and/or a conductive material.

For example, in some embodiments, the positive electrode may further include an additive that may function as a sacrificial positive electrode.

A content (e.g., amount) of the positive electrode active material may be about 90 wt % to about 99.5 wt %, and a content (e.g., amount) of each of the binder and the conductive material may be about 0.5 wt % to about 5 wt %, based on 100 wt % of a total weight of the positive electrode active material layer.

The binder serves to attach the positive electrode active material particles well to each other and also to attach the positive electrode active material well to the positive electrode current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, but embodiments of the present disclosure are not limited thereto.

The conductive material may be utilized to impart conductivity (e.g., electrical conductivity) to the electrode. Any material that does not cause chemical change (e.g., does not cause an undesirable chemical change in the rechargeable lithium battery) and conducts electrons may be utilized in the battery. Non-limiting examples of the conductive material may include a carbon-based material such as natural graphite, artificial graphite, carbon black, acetylene black, Ketjen black, a carbon fiber, a carbon nanofiber, and/or carbon nanotube; a metal-based material including copper, nickel, aluminum, silver, and/or the like, in a form of a metal powder or a metal fiber; a conductive polymer such as a polyphenylene derivative; and/or a (e.g., any suitable) mixture thereof.

In one or more embodiments, the positive electrode current collector may include Al, but embodiments of the present disclosure are not limited thereto.

### Negative Electrode Active Material

The negative electrode active material may be a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include a carbon-based negative electrode active material, for example, crystalline carbon, amorphous carbon, and/or a (e.g., any suitable) combination thereof. The crystalline carbon may be graphite such as non-shaped (e.g., irregularly shaped), plate-shaped, flake-shaped, sphere-shaped, or fiber-shaped natural graphite and/or artificial graphite. The amorphous carbon may be a soft carbon, a hard carbon, a mesophase pitch carbonization product, calcined coke, and/or the like.

The lithium metal alloy may include lithium and a metal selected from among sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material capable of doping/dedoping lithium may be a Si-based negative electrode active material or a Sn-based negative electrode active material. The Si-based negative electrode active material may include silicon, a silicon-carbon composite, SiOₓ (0<x≤2), a Si-Q alloy (wherein Q is selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof). The Sn-based negative electrode active material may include Sn, SnOk (0<k≤2) (e.g., SnO₂), a Sn-based alloy, and/or a (e.g., any suitable) combination thereof.

The silicon-carbon composite may be a composite of silicon and amorphous carbon (e.g., in a form of particles). According to one or more embodiments, the silicon-carbon composite may be in a form of silicon particles and amorphous carbon coated on the surface of each of the silicon particles. For example, in one or more embodiments, the silicon-carbon composite may include a secondary particle (core) in which silicon primary particles are assembled, and an amorphous carbon coating layer (shell) on the surface of the secondary particle. The amorphous carbon may also be between the silicon primary particles, and, for example, the silicon primary particles may be coated with the amorphous carbon. The secondary particle may exist dispersed in an amorphous carbon matrix.

In one or more embodiments, the silicon-carbon composite may further include crystalline carbon. For example, the silicon-carbon composite may include a core including crystalline carbon and silicon particles and an amorphous carbon coating layer on a surface of the core.

In one or more embodiments, the Si-based negative electrode active material or the Sn-based negative electrode active material may be utilized in combination with a carbon-based negative electrode active material.

### Negative Electrode

The negative electrode for a rechargeable lithium battery may include a negative electrode current collector and a negative electrode active material layer on the negative electrode current collector. The negative electrode active material layer includes a negative electrode active material and may further include a binder and/or a conductive material.

In one or more embodiments, the negative electrode active material layer may include about 90 wt % to about 99 wt % of the negative electrode active material, about 0.5 wt % to about 5 wt % of the binder, and about 0.5 wt % to about 5 wt % of the conductive material, based on 100 wt % (weight percent) of a total weight of the negative electrode active material layer.

The binder may serve to attach the negative electrode active material particles well to each other and also to attach the negative electrode active material well to the negative electrode current collector. The binder may include a non-aqueous (e.g., water-insoluble) binder, an aqueous (water-soluble) binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polymide, and/or a (e.g., any suitable) combination thereof.

The aqueous binder may be selected from among a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and/or a (e.g., any suitable) combination thereof.

When an aqueous binder is utilized as the binder of the negative electrode, it may further include a cellulose-based compound capable of imparting viscosity. The cellulose-based compound may include one or more of carboxylmethyl cellulose, hydroxypropylmethyl cellulose, methyl cellulose, or one or more alkali metal salts thereof. The alkali metal may be Na, K, or Li.

The dry binder may be a polymer material capable of being fiberized, and may be, for example, polytetrafluoroethylene, polyvinylidene fluoride, a polyvinylidene fluoride-hexafluoropropylene copolymer, polyethylene oxide, and/or a (e.g., any suitable) combination thereof.

The conductive material is included to provide electrode conductivity, and any electrically conductive material may be utilized as a conductive material unless it causes a chemical change. Non-limiting examples of the conductive material may be a carbon-based material such as natural graphite, artificial graphite, carbon black, acetylene black, Ketjen black, a carbon fiber, a carbon nanofiber, a carbon nanotube, and/or the like; a metal-based material such as copper, nickel, aluminum silver, and/or the like in a form of a metal powder or a metal fiber; a conductive polymer such as a polyphenylene derivative; and/or a (e.g., any suitable) mixture thereof.

The negative electrode current collector may include one selected from among a copper foil, a nickel foil, a stainless steel foil, a titanium foil, a nickel foam, a copper foam, a polymer substrate coated with a conductive metal, and/or a (e.g., any suitable) combination thereof, but embodiments of the present disclosure are not limited thereto.

### Separator

Depending on the type or kind of the rechargeable lithium battery, a separator may be present between the positive electrode and the negative electrode. The separator may include polyethylene, polypropylene, polyvinylidene fluoride, or a multilayer film of two or more layers thereof, or may include a mixed multilayer film such as a polyethylene/polypropylene two-layer separator, polyethylene/polypropylene/polyethylene three-layer separator, polypropylene/polyethylene/polypropylene three-layer separator, and/or the like.

The separator may include a porous substrate and a coating layer including an organic material, an inorganic material, and/or a (e.g., any suitable) combination thereof on a surface (e.g., one or both (e.g., simultaneously) surfaces or sides (e.g., opposite surfaces)) of the porous substrate.

The porous substrate may be a polymer film formed of any one selected from among polyolefin such as polyethylene and/or polypropylene, a polyester such as polyethyleneterephthalate and/or polybutyleneterephthalate, polyacetal, polyamide, polymide, polycarbonate, polyether ketone, polyaryl ether ketone, polyether imide, polyamideimide, polybenzimidazole, polyether sulfone, polyphenyleneoxide, a cyclic olefin copolymer, polyphenylenesulfide, polyethylenenaphthalate, a glass fiber, and polytetrafluoroethylene (e.g., TEFLON), or may be a copolymer or a mixture including two or more thereof.

The organic material may include a polyvinylidene fluoride-based polymer and/or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but embodiments of the present disclosure are not limited thereto.

In one or more embodiments, the organic material and the inorganic material may be mixed in one coating layer, or a coating layer including an organic material and a coating layer including an inorganic material may be stacked.

### Rechargeable Lithium Battery

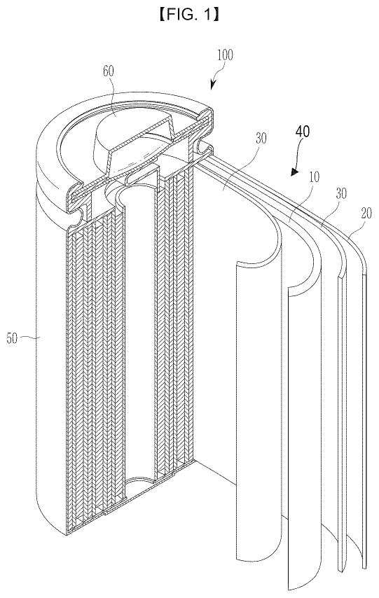

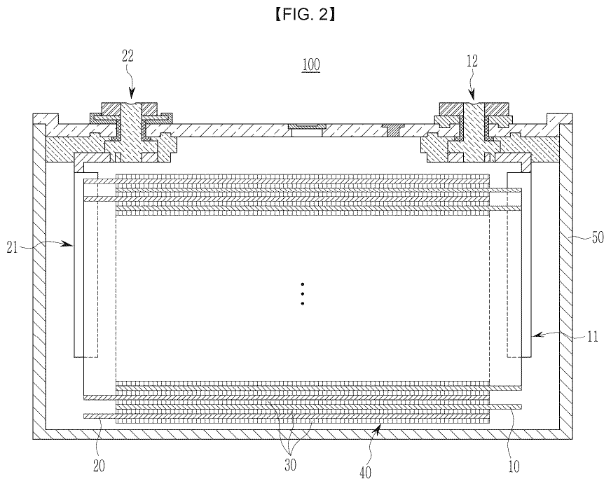

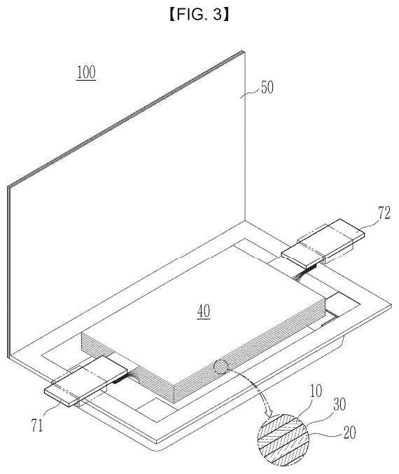

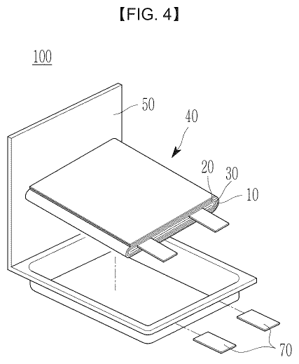

The rechargeable lithium battery may be classified into a cylindrical, prismatic, pouch, or coin-type or kind battery, and/or the like, depending on the shape thereof. FIGS. 1 to 4 are each a schematic view illustrating a rechargeable lithium battery according to one or more embodiments of the present disclosure. FIG. 1 shows a cylindrical battery, FIG. 2 shows a prismatic battery, and FIGS. 3 and 4 each show a pouch-type or kind battery. Referring to FIGS. 1 to 4, the rechargeable lithium battery 100 may include an electrode assembly 40 including a separator 30 between a positive electrode 10 and a negative electrode 20, and a case 50 in which the electrode assembly 40 is housed. The positive electrode 10, the negative electrode 20, and the separator 30 may be impregnated with an electrolyte. In some embodiments, the rechargeable lithium battery 100 may include a sealing member 60 sealing the case 50 as shown in FIG. 1. In one or more embodiments, as shown in FIG. 2, the rechargeable lithium battery 100 may include a positive lead tab 11, a positive terminal 12, a negative lead tab 21, and a negative terminal 22. As shown in FIGS. 3 and 4, in some embodiments, the rechargeable lithium battery 100 includes an electrode tab 70, which may include a positive electrode tab 71 and a negative electrode tab 72, serving as an electrical path for inducing the current formed in the electrode assembly 40 to the outside.

The rechargeable lithium battery according to one or more embodiments may be applied to automobiles, mobile phones, and/or one or more suitable types (kinds) of electrical devices, but embodiments of the present disclosure are not limited thereto.

Hereinafter, examples of the present disclosure and comparative examples are described. These examples, however, are not in any sense to be interpreted as limiting the scope of present disclosure.

### Example 1

### (1) Preparation of Electrolyte

As a non-aqueous organic solvent, a carbonate based solvent prepared by mixing ethylene carbonate (EC):ethylmethyl carbonate (EMC):dimethyl carbonate (DMC) in a volume ratio of 20:40:40 was utilized.

The non-aqueous organic solvent was mixed with 1.5 M lithium salt (LiPF₆), and 0.5 wt % of a first additive represented by Chemical Formula 1-2a-2 and 0.25 wt % of a second additive represented by Chemical Formula 2-2 were added thereto to obtain an electrolyte.

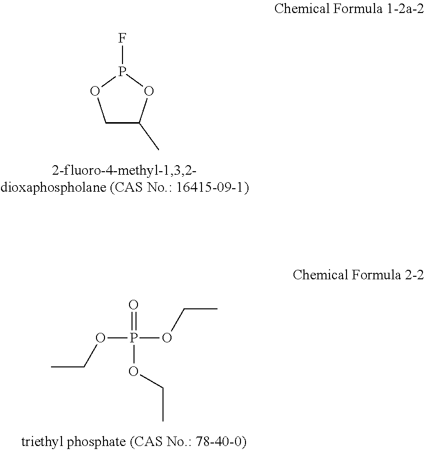

In the electrolyte composition, “wt %” was based on a total content (e.g., amount) of the electrolyte (lithium salt+non-aqueous organic solvent+additives). Hereinafter, the same as above was applied.

### (2) Manufacture of Rechargeable Lithium Battery Cell

LiNi_{0.75}Mn_{0.23}Al_{0.02}O₂ as a positive electrode active material, polyvinylidene fluoride as a binder, and acetylene black as a conductive material were mixed in a weight ratio of 96:3:1 and then, dispersed in N-methyl pyrrolidone to prepare a positive electrode active material slurry.

The positive electrode active material slurry was coated on a 14 μm-thick Al foil and then, dried at 110° C. and pressed to manufacture a positive electrode.

On the other hand, a negative electrode active material slurry was prepared by utilizing a mixture of artificial graphite and a silicon-carbon composite in a weight ratio of 93.5:6.5 as a negative electrode active material and mixing the negative electrode active material: styrene-butadiene rubber binder:carboxylmethyl cellulose in a weight ratio of 97:1:2 and then, dispersing the obtained mixture in distilled water. The silicon-carbon composite had silicon particles and amorphous carbon coated on the surface of the silicon particles.

The negative electrode active material slurry was coated on a 10 μm-thick Cu foil, dried at 100° C., and pressed to manufacture a negative electrode.

The positive electrode and the negative electrode were assembled with a 25 μm-thick polyethylene separation membrane to manufacture an electrode assembly, the electrode assembly was housed in a prismatic case, and the electrolyte was implanted thereinto, manufacture a rechargeable lithium battery cell.

### Example 2

An electrolyte and a rechargeable lithium battery cell according to Example 2 were each manufactured in substantially the same manner as in Example 1 except that the contents of the first additive represented by Chemical Formula 1-2a-2 and the second additive represented by Chemical Formula 2-2 were respectively changed to 0.5 wt % and 0.5 wt %.

### Example 3

An electrolyte and a rechargeable lithium battery cell according to Example 3 were each manufactured in substantially the same manner as in Example 1 except that the contents of the first additive represented by Chemical Formula 1-2a-2 and the second additive represented by Chemical Formula 2-2 were respectively changed to 0.5 wt % and 1 wt %.

### Example 4

An electrolyte and a rechargeable lithium battery cell according to Example 4 were each manufactured in substantially the same manner as in Example 1 except that the contents of the first additive represented by Chemical Formula 1-2a-2 and the second additive represented by Chemical Formula 2-2 were respectively changed to 0.75 wt % and 0.25 wt %.

### Example 5

An electrolyte and a rechargeable lithium battery cell according to Example 5 were each manufactured in substantially the same manner as in Example 1 except that the contents of the first additive represented by Chemical Formula 1-2a-2 and the second additive represented by Chemical Formula 2-2 were respectively changed to 0.75 wt % and 0.5 wt %.

### Example 6

An electrolyte and a rechargeable lithium battery cell according to Example 6 were each manufactured in substantially the same manner as in Example 1 except that a second additive represented by Chemical Formula 2-6 was utilized instead of the second additive represented by Chemical Formula 2-2, and the first additive represented by Chemical Formula 1-2a-2 and the second additive represented by Chemical Formula 2-6 were each utilized in an amount of 0.5 wt %.

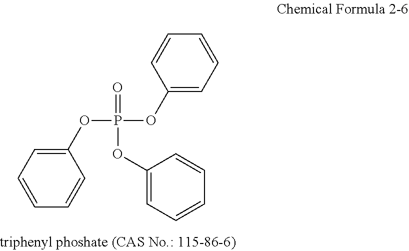 [SMILES: O=P(Oc1ccccc1)(Oc1ccccc1)Oc1ccccc1]

### Example 7

A rechargeable lithium battery cell was manufactured in substantially the same manner as in Example 2 except that LiNi_{0.91}Co_{0.04}Al_{0.05}O₂ instead of the LiNi_{0.75}Mn_{0.23}Al_{0.02}O₂ was utilized as the positive electrode active material. And the same electrolyte as utilized in Example 2 was utilized.

### Comparative Example 1 (Ref.)

### (1) Preparation of Electrolyte

An electrolyte was prepared by mixing ethylene carbonate (EC):ethylmethyl carbonate (EMC):dimethyl carbonate (DMC) in a volume ratio of 20:40:40 to prepare a carbonate based solvent and dissolving 1.5 M lithium salt (LiPF₆) therein.

### (2) Manufacture of Rechargeable Lithium Battery Cell

A rechargeable lithium battery cell was manufactured in substantially the same manner as in Example 1 except that the prepared electrolyte was utilized.

### Comparative Example 2

### (1) Preparation of Electrolyte

As a non-aqueous organic solvent, a carbonate based solvent prepared by mixing ethylene carbonate (EC):ethylmethyl carbonate (EMC):dimethyl carbonate (DMC) in a volume ratio of 20:40:40 was utilized.

The non-aqueous organic solvent was mixed with 1.5 M lithium salt (LiPF₆), and 0.5 wt % of the first additive represented by Chemical Formula 1-2a-2 was added thereto to obtain an electrolyte of Comparative Example 2.

### (2) Manufacture of Rechargeable Lithium Battery Cell

A rechargeable lithium battery cell was manufactured in substantially the same manner as in Example 1 except that the electrolyte of Comparative Example 2 was utilized.

### Comparative Example 3

### (1) Preparation of Electrolyte

As a non-aqueous organic solvent, a carbonate based solvent prepared by mixing ethylene carbonate (EC):ethylmethyl carbonate (EMC):dimethyl carbonate (DMC) in a volume ratio of 20:40:40 was utilized.

The non-aqueous organic solvent was mixed with 1.5 M lithium salt (LiPF₆), and 0.5 wt % of the second additive represented by Chemical Formula 2-2 was added thereto to obtain an electrolyte of Comparative Example 3.

### (2) Manufacture of Rechargeable Lithium Battery Cell

A rechargeable lithium battery cell of Comparative Example 3 was manufactured in substantially the same manner as in Example 1 except that the electrolyte of Comparative Example 3 was utilized.

### Comparative Example 4

### (1) Preparation of Electrolyte

As a non-aqueous organic solvent, a carbonate based solvent prepared by mixing ethylene carbonate (EC):ethylmethyl carbonate (EMC):dimethyl carbonate (DMC) in a volume ratio of 20:40:40 was utilized.

The non-aqueous organic solvent was mixed with 1.5 M lithium salt (LiPF₆), and 0.5 wt % of the first additive represented by Chemical Formula 1-2a-2 and 0.5 wt % of a third additive represented by Chemical Formula 3 were added thereto to obtain an electrolyte of Comparative Example 4.

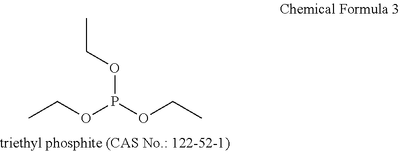

### (2) Manufacture of Rechargeable Lithium Battery Cell

A rechargeable lithium battery cell of Comparative Example 4 was manufactured in substantially the same manner as in Example 1 except that the electrolyte of Comparative Example 4 was utilized.

### Comparative Example 5

### (1) Preparation of Electrolyte

As a non-aqueous organic solvent, a carbonate based solvent prepared by mixing ethylene carbonate (EC):ethylmethyl carbonate (EMC):dimethyl carbonate (DMC) in a volume ratio of 20:40:40 was utilized.

The non-aqueous organic solvent was mixed with 1.5 M lithium salt (LiPF₆), and 0.5 wt % of a fourth additive represented by Chemical Formula 4 and 0.5 wt % of the second additive represented by Chemical Formula 2-2 were added thereto to obtain an electrolyte of Comparative Example 5.

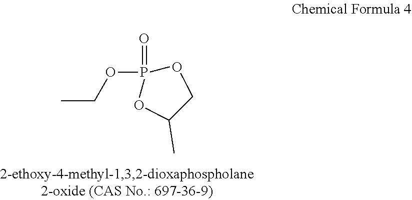

### (2) Manufacture of Rechargeable Lithium Battery Cell

A rechargeable lithium battery cell of Comparative Example 5 was manufactured in substantially the same manner as in Example 1 except that the electrolyte of Comparative Example 5 was utilized.

For reference, the contents of the additives of each electrolyte according to Examples 1 to 7 and Comparative Examples 1 to 5 were summarized in Table 1.

TABLE 1
(unit: wt %)

| | First | | | Third | Fourth |
|---|---|---|---|---|---|
| | additive | Second additive | | additive | additive |
| | (Chemical | (Chemical | (Chemical | (Chemical | (Chemical |
| | Formula | Formula | Formula | Formula | Formula |
| | 1-2a-2) | 2-2) | 2-6) | 3) | 4) |
| Example 1 | 0.5 | 0.25 | — | — | — |
| Example 2 | 0.5 | 0.5 | — | — | — |
| Example 3 | 0.5 | 1 | — | — | — |
| Example 4 | 0.75 | 0.25 | — | — | — |
| Example 5 | 0.75 | 0.5 | — | — | — |
| Example 6 | 0.5 | — | 0.5 | — | — |
| Example 7 | 0.5 | 0.5 | — | — | — |
| Comparative | — | — | — | — | — |
| Example 1 | | | | | |
| Comparative | 0.5 | — | — | — | — |
| Example 2 | | | | | |
| Comparative | — | 0.5 | — | — | — |
| Example 3 | | | | | |
| Comparative | 0.5 | — | — | 0.5 | — |
| Example 4 | | | | | |
| Comparative | — | 0.5 | — | — | 0.5 |
| Example 5 | | | | | |

### Evaluation Example 1: Cycle-Life Characteristics Depending on Temperature

Each of the rechargeable lithium battery cells of Examples 1 to 7 and Comparative Examples 1 to 5 was evaluated with respect to cycle-life characteristics according to a temperature in the following methods, and the results are shown in Table 2.

### (1) Room-Temperature Cycle-Life Characteristics

The rechargeable lithium battery cells were each 200 cycles charged and discharged under conditions of 0.5 C charge (CC/CV, 4.45 V, 0.025 C Cut-off)/1.0 C discharge (CC, 2.5 V Cut-off) at 25° C., and a capacity retention rate thereof was calculated according to Equation 1.

### (2) High-Temperature Cycle-Life Characteristics

The rechargeable lithium battery cells were each 200 cycles charged and discharged under conditions of 0.5 C charge (CC/CV, 4.45 V, 0.025 C Cut-off)/1.0 C discharge (CC, 2.5 V Cut-off) at 45° C., and a capacity retention rate thereof was calculated according to Equation 1.

$$Capacity retention rate [ \% ] = ( Discharge capacity after 200 cycles / Discharge capacity after 1 cycle ) * 100 \qquad Equation 1$$

### Evaluation Example 2: High-Temperature Storage Characteristics

Each of the rechargeable lithium battery cells of Examples 1 to 7 and Comparative Examples 1 to 5 was stored at a high temperature in the following methods to evaluate a DC-IR increase rate, a capacity retention rate, and a gas generation amount, and the results are shown in Table 2.

### (1) DC-IR Increase Rate

The rechargeable lithium battery cells immediately after the manufacture were each measured with respect to ΔV/ΔI (voltage change/current change) to evaluate initial DC resistance (initial DC-IR).

Subsequently, the rechargeable lithium battery cells were each charged to SOC 100% (a state of being charged to 100% of charge capacity based on 100% of total battery charge capacity) and then, stored at 60° C. for 30 days.

Each of the rechargeable lithium battery cells after the high temperature storage was measured with respect to ΔV/ΔI (voltage change/current change) to evaluate DC internal resistance (DC-IR after the high temperature storage).

A DC-IR increase rate was calculated according to Equation 2, and the results are shown in Table 2.

$$DC - IR increase rate [ \% ] = ( DC - IR after high - temperature storage / initial DC - IR ) * 100 \qquad Equation 2$$

The rechargeable lithium battery cells immediately after the manufacture were each once charged and discharged under conditions of 0.33 C charge (CC/CV, 4.45 V, 0.025 C Cut-off)/0.33 C discharge (CC, 2.5 V Cut-off) to measure discharge capacity (initial discharge capacity).

Subsequently, the rechargeable lithium battery cells were each charged to SOC 100% (a state of being charged to 100% of charge capacity based on 100% of total battery charge capacity) and then, stored at 60° C. for 30 days. The rechargeable lithium battery cells immediately after the high temperature storage were each once charged and discharged under conditions of 0.33 C charge (CC/CV, 4.45 V, 0.025 C Cut-off)/0.33 C discharge (CC, 2.5 V Cut-off) to measure discharge capacity (discharge capacity after the high temperature storage).

Each capacity retention rate of the cells was calculated according to Equation 3.

$$Capacity retention rate [ \% ] = ( discharge capacity after high - temperature storage / initial discharge capacity ) * 100 \qquad Equation 3$$

### (4) Gas Generation Amount

The rechargeable lithium battery cells were each charged to SOC 100% (a state of being charged 100% of charge capacity based on 100% of total battery charge capacity) and then, stored at 60° C. for 30 days. The rechargeable lithium battery cells after the high temperature storage were each measured with respect to a gas generation amount [mL] by utilizing Refinery Gas Analysis (RGA).

TABLE 2

| | | | High-temperature storage | | |
|---|---|---|---|---|---|
| | | | characteristics | | |
| | Cycle-life characteristics | | DC-IR | Capacity | Gas |
| | Capacity | Capacity | increase | retention | generation |
| | retention | retention | rate | rate | amount |
| | rate | rate | @ | @ | @ |
| | @ 25° C., | @ 45° C., | 60° C., | 60° C., | 60° C., |
| | 200 Cyc. | 200 Cyc. | 30 Day | 30 Day | 30 Day |
| | [%] | [%] | [%] | [%] | [mL] |
| Example 1 | 97.89 | 93.91 | 117.2 | 97.7 | 12.95 |
| Example 2 | 98.12 | 94.42 | 115.8 | 98.4 | 12.65 |
| Example 3 | 98.3 | 94.76 | 112.4 | 98.9 | 12.14 |
| Example 4 | 97.83 | 94.01 | 116.9 | 97.6 | 12.80 |
| Example 5 | 98.09 | 94.28 | 115.4 | 98.4 | 12.37 |
| Example 6 | 98.27 | 94.51 | 116.7 | 98.5 | 12.49 |
| Example 7 | 98.05 | 94.5 | 115.1 | 98.6 | 12.74 |
| Comparative | 92.48 | 87.62 | 127.5 | 94.3 | 14.78 |
| Example 1 | | | | | |
| Comparative | 96.15 | 91.21 | 122.3 | 96.2 | 13.25 |
| Example 2 | | | | | |
| Comparative | 95.79 | 90.90 | 121.7 | 96.8 | 13.49 |
| Example 3 | | | | | |
| Comparative | 96.09 | 91.08 | 123.1 | 95.8 | 13.41 |
| Example 4 | | | | | |
| Comparative | 95.84 | 91.17 | 120.9 | 96.7 | 13.2 |
| Example 5 | | | | | |

Referring to Table 2, Examples 1 to 7, compared with Comparative Examples 1 to 5, each exhibited improved cycle-life characteristics and high-temperature storage characteristics.

The electrolyte according to one or more embodiments, which was employed in Examples 1 to 7, may thus suppress or reduce side reactions (e.g., gas generation, increase in interface resistance, and/or the like.) occurring on the interface between the negative electrode and the electrolyte, regardless of an operating temperature and an upper charging limit voltage, and also, improve cycle-life of rechargeable lithium batteries.

In addition, referring to Examples 1 to 7, these beneficial effects may to be controlled or selected by adjusting a mixing ratio (weight ratio) of the first additive to the second additive.

In addition, Examples 1 to 6 each utilizing cobalt-free nickel-manganese-based oxide as a positive electrode active material exhibited substantially equivalent cycle-life characteristics and high-temperature storage characteristics to that of Example 7 utilizing lithium nickel-based oxide as a positive electrode active material.

Accordingly, the electrolyte according to one or more embodiments utilized in Examples 1 to 7, in which a structurally unstable positive electrode active material was utilized, may suppress or reduce side reactions (e.g., gas generation, increase in interface resistance, and/or the like.) on the interface of the negative electrode and the electrolyte and also, improve the cycle-life of the rechargeable lithium battery.

In the present disclosure, the term “comprise(s)/comprising”, “include(s)/including”, or “have (has)/having” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

In present disclosure, The term “Group” as utilized herein refers to a group of the Periodic Table of Elements according to the 1 to 18 grouping system of the International Union of Pure and Applied Chemistry (“IUPAC”).

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

While the present disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims and equivalents thereof.

Reference Numerals

| | |
|---|---|
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 60: sealing member | 70: electrode tab |
| 71: positive electrode tab | 72: negative electrode tab |

What is claimed is:

1. An electrolyte, comprising:
a non-aqueous organic solvent;
a lithium salt;
a first additive represented by Chemical Formula 1; and
a second additive represented by Chemical Formula 2: 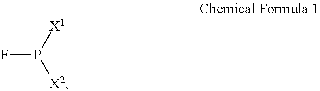
wherein, in Chemical Formula 1,
X¹ and X² are each a halogen or —O-L¹-R¹, provided that at least one of X¹ or X² is —O-L¹-R¹;
L¹ is a single bond or a substituted or unsubstituted C1 to C10 alkylene group;
R¹ is a cyano group (—CN), a difluorophosphite group (—OPF₂), a substituted or unsubstituted C1 to C10 alkyl group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group; and
when X¹ and X² are each —O-L¹-R¹ at the same time,
R¹(s) are each independently present, or two R¹(s) are linked to form a substituted or unsubstituted monocyclic or polycyclic C6 to C20 aliphatic heterocycle, or a substituted or unsubstituted monocyclic or polycyclic C6 to C20 aromatic heterocycle, 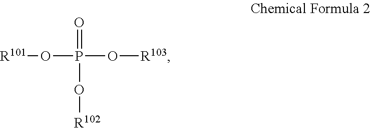
wherein, in Chemical Formula 2,
R¹⁰¹ to R¹⁰³ are each independently a substituted or unsubstituted C1 to C10 alkyl group, a substituted or unsubstituted C6 to C10 aryl group, or a substituted or unsubstituted C2 to C10 heteroaryl group containing a heteroatom of N, O, or P, and/or two selected from among R¹⁰¹ to R¹⁰³ are linked to form a substituted or unsubstituted monocyclic or polycyclic C6 to C20 aliphatic heterocycle or a substituted or unsubstituted monocyclic or polycyclic C6 to C20 aromatic heterocycle, and the remaining one group is a substituted or unsubstituted C1 to C10 alkyl group, a substituted or unsubstituted C6 to C10 aryl group, or a substituted or unsubstituted C2 to C10 heteroaryl group containing a heteroatom of N, O, or P, and
wherein the electrolyte is for a rechargeable lithium battery.

2. The electrolyte as claimed in claim 1, wherein,
in Chemical Formula 1,
one selected from among X¹ and X² is fluorine and the other is —O-L²-R²; or
one selected from X¹ and X² is —O-L³-R³ and the other is —O-L⁴-R⁴, and
wherein:
L² is a single bond or a substituted or unsubstituted C1 to C10 alkylene group;
R² is a cyano group (—CN) or a difluorophosphite group (—OPF₂);
L³ and L⁴ are each independently a single bond or a substituted or unsubstituted C1 to C10 alkylene group; and
R³ and R⁴ are each independently a substituted or unsubstituted C1 to C10 alkyl group; or R³ and R⁴ are linked to form a substituted or unsubstituted monocyclic or polycyclic C3 to C10 aliphatic heterocycle.

3. The electrolyte as claimed in claim 2, wherein,
the first additive represented by Chemical Formula 1 is represented by Chemical Formula 1-1 or Chemical Formula 1-2: 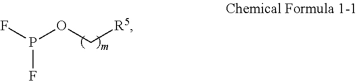
in Chemical Formula 1-1,
m being an integer of 1 to 5; and
R⁵ being a cyano group (—CN) or a difluorophosphite group (—OPF₂); and 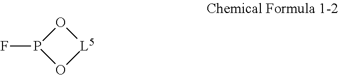
in Chemical Formula 1-2,
L⁵ being a substituted or unsubstituted C1 to C5 alkylene group.

4. The electrolyte as claimed in claim 3, wherein,
the first additive represented by Chemical Formula 1-2 is represented by Chemical Formula 1-2a or Chemical Formula 1-2b: 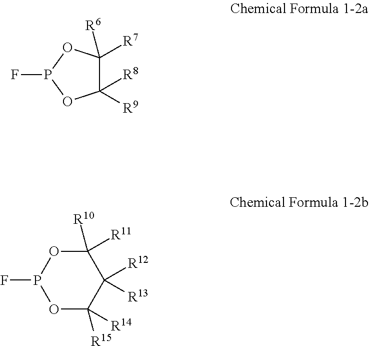
in Chemical Formula 1-2a and Chemical Formula 1-2b,
R⁶ to R¹⁵ being each independently hydrogen, a halogen, or a substituted or unsubstituted C1 to C5 alkyl group.

5. The electrolyte as claimed in claim 1, wherein,
the first additive comprises at least one compound selected from among compounds represented by Chemical Formula 1-1a-1, Chemical Formula 1-1a-2, Chemical Formula 1-2a-1, and Chemical Formula 1-2a-2:

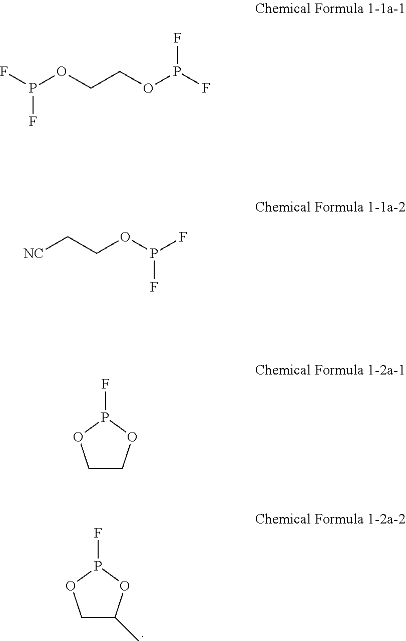

6. The electrolyte as claimed in claim 1, wherein,
in Chemical Formula 2,
R¹⁰¹ to R¹⁰³ are each independently a substituted or unsubstituted C1 to C5 alkyl group or a substituted or unsubstituted C6 to C10 aryl group, and/or
two selected from among R¹⁰¹ to R¹⁰³ groups are linked to form a substituted or unsubstituted monocyclic C6 to C10 aliphatic heterocycle, and the remaining one group is a substituted or unsubstituted C1 to C5 alkyl group.

7. The electrolyte as claimed in claim 1, wherein,
the second additive comprises at least one compound selected from among compounds represented by Chemical Formulae 2-1 to 2-9:

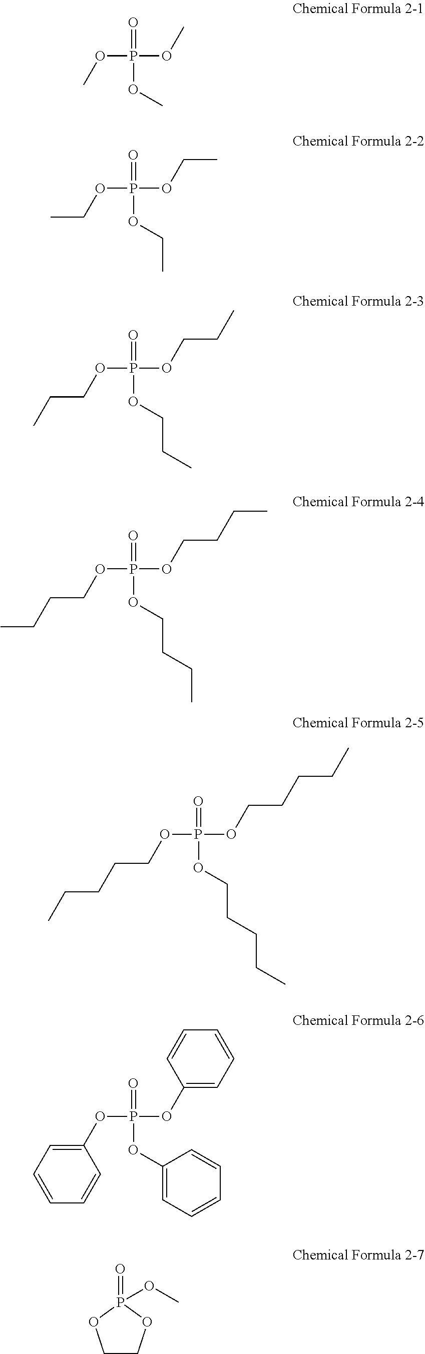

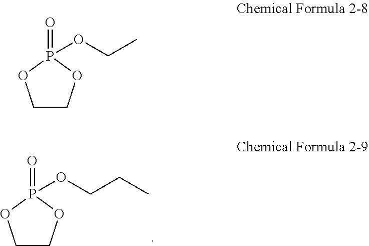

8. The electrolyte as claimed in claim 1, wherein,
a weight ratio of the first additive to the second additive is about 10:1 to about 1:10.

9. The electrolyte as claimed in claim 1, wherein,
the first additive is in an amount of about 0.1 to about 5 wt % based on a total weight of the electrolyte.

10. The electrolyte as claimed in claim 1, wherein,
the second additive is in an amount of about 0.1 to about 10 wt % based on a total weight of the electrolyte.

11. The electrolyte as claimed in claim 1, wherein,
the non-aqueous organic solvent comprises a mixture of ethylene carbonate (EC), ethylmethyl carbonate (EMC), and dimethyl carbonate (DMC).

12. The electrolyte as claimed in claim 1, wherein,
the lithium salt comprises LiPF₆.

13. The electrolyte as claimed in claim 1, wherein,
a molar concentration of lithium salt in the electrolyte is about 1.0 to about 2.0 M.

14. A rechargeable lithium battery, comprising:
a positive electrode comprising a positive electrode active material;
a negative electrode comprising a negative electrode active material; and
the electrolyte as claimed in claim 1.

15. The rechargeable lithium battery as claimed in claim 14, wherein,
the positive electrode active material comprises a lithium nickel-based oxide, a lithium cobalt-based oxide, a lithium manganese-based oxide, a lithium iron phosphate-based compound, a cobalt-free lithium nickel-manganese-based oxide, or a combination thereof.

16. The rechargeable lithium battery as claimed in claim 15, wherein,
the positive electrode active material comprises a cobalt-free lithium nickel-manganese-based oxide represented by Chemical Formula 14:
Liₐ₄Niₓ₄Mn_{y4}M⁵_{z4}O_{2-b4}X_{b4} Chemical Formula 14
in Chemical Formula 14,
0.9≤a4≤1.8, 0.8≤x4≤1, 0≤y4≤0.2, 0≤z4≤0.2, 0.9≤x4+y4+z4≤1.1, and 0≤b4≤0.1,
M⁵ being one or more element selected from among Al, B, Ba, Ca, Ce, Cr, Fe, Mg, Mo, Nb, Si, Sn, Sr, Ti, V, W, and Zr, and
X being one or more selected from among F, P, and S.
